(19) United States
(12) Patent Application Publication
(10) Pub. No.: US 2025/0054007 A1
(43) Pub. Date: Feb. 13, 2025

(54) AFFORDABILITY SWEET SPOT IDENTIFICATION

(71) Applicant: Capital One Services, LLC, McClean, VA (US)

(72) Inventor: Bryan PARKER, Richardson, TX (US)

(73) Assignee: Capital One Services, LLC, McLean, VA (US)

(21) Appl. No.: 18/231,964

(22) Filed: Aug. 9, 2023

(51) Int. Cl. G06Q 30/0201; G06Q 30/0204

(52) U.S. Cl. CPC G06Q 30/0206; G06Q 30/0204

(57) ABSTRACT

A system and method for generating offers is disclosed. The system and method can receive a identifier identifying a given item. A list of alternative inventory items may be generated for an item. A plurality of merchant and customer historic deal metrics may be determined based on past purchases for each of the alternative inventory items. A first and second cluster of data points may be generated based on the plurality of merchant and customer historic deal metrics. An overlap region between the first cluster and the second cluster may be determined. A data point from amongst the data points within the overlap region may be selected. An offer may be generated for the given item based on the selected data point. The offer may be transmitted to the client device for display on a graphical user interface (GUI).

### TECHNICAL FIELD

Aspects relate to systems and methods for enhanced merchant-lender computing systems.

### BACKGROUND

Determining what type of offers are acceptable to merchants and customers when purchasing an item (e.g., a vehicle, luxury good, service, etc.) is not apparent from the outset of a negotiation. For example, when purchasing a vehicle, merchants and customers can spend an entire day negotiating prices, financing terms, etc., until they reach mutually acceptable terms. Moreover, in the event that the item to be purchased has to be financed, and even if an offer is acceptable to both parties, it is unclear whether the customer is qualified to finance the item at the settled offer price. Thus, systems and methods are needed to improve current processes and help facilitate finding a mutually acceptable price point and deal terms for both a merchant and a customer.

### SUMMARY

Aspects of this disclosure are directed to a system and methods for automatically generating offers that are likely to be acceptable to both a merchant and a customer when the customer wants to purchase an item from the merchant. The item may be any good or service. For example, the item may be a car, boat, house, luxury good, or a service such as home improvement services, etc. The offer generated by the system is unique in that it is highly custom to both the customer and the merchant. The offer may be determined based on taking into account historic deal metrics of past sales of similar items by the merchant. The system can also take into account historic deal metrics of past purchases of similar items by other customers, in addition to customer financial information of the customer wanting to purchase the item (e.g., credit history, account balances, etc.). Based on analyzing the various metrics and utilizing custom processes and techniques, the system can generate the offer. The offer, once generated, may be transmitted to a merchant and/or a customer.

The ability of the system to generate highly targeted offers improves conventional systems and processes because currently these conventional systems do not take into account historic deal metrics for both parties to generate offers. Thus, the system provides a way to significantly reduce time negotiating deal terms by leveraging technology and data in an intelligent manner to derive deal terms likely to be acceptable to both parties. In aspects, the system can also learn from the offers it generates and can have feedback input back into the system relating to whether the offer was accepted or not, how much the offer was off by, what the ultimate acceptable terms of the offer were, etc. so as to continually learn and to constantly improve its ability to generate offers.

In aspects, the system and methods can implement the above functionality by receiving, via an application, an identifier identifying an item. In aspects, and for a merchant, the system can generate a list of alternative inventory items to the item. In aspects, a plurality of merchant historic deal metrics may be determined based on past purchases for each of the alternative inventory items. In aspects, and utilizing a clustering procedure, a first cluster of data points may be generated based on the plurality of merchant historic deal metrics. In aspects, the system can further determine a plurality of customer historic deal metrics based on past purchases for each of the alternative inventory items. In aspects, a second cluster of data points based on the plurality of customer historic deal metrics may be generated. In aspects, an overlap region between the first cluster and the second cluster may be determined. In aspects, a data point from amongst the data points within the overlap region may be selected. In aspects, an offer may be generated for the given item based on the selected data point. In aspects, the offer may be transmitted to the client device for display on a graphical user interface (GUI).

Various methods may be used to select the data point as will be described. In aspects, the system may be implemented such that it generates the offer in real-time from when the identifier identifying the given item is received. In aspects, the data may be filtered such that the plurality of customer historic deal metrics used include only customer historic deal metrics for customers within a banded credit risk profile as a user associated with a user account of the application from which the identifier is received. In aspects, filtering may be performed such that the plurality of customer historic deal metrics used include only customer historic deal metrics for customers within a monthly income range as a user associated with a user account of the application from which the identifier is received. In aspects, the system and methods may be implemented on devices of a cloud computing environment.

Certain aspects of the disclosure have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

The accompanying drawings, which are incorporated herein and form a part of the specification, illustrate aspects of the present disclosure and, together with the description, further serve to explain the principles of the disclosure and to enable a person skilled in the art to make and use the aspects.

FIG. 1 is an example system for generating offers according to aspects.

FIG. 2 is an example of the clustering performed by the system according to aspects.

FIG. 3 is an example method of operating the system according to aspects.

FIG. 4 is an example GUI displaying the offer to a customer according to aspects.

FIG. 5 is an example architecture of the components of the system according to aspects.

In the drawings, like reference numbers generally indicate identical or similar elements. Additionally, generally, the left-most digit(s) of a reference number identifies the drawing in which the reference number first appears.

### DETAILED DESCRIPTION

The following aspects are described in sufficient detail to enable those skilled in the art to make and use the disclosure. It is to be understood that other aspects are evident based on the present disclosure, and that system, process, or mechanical changes may be made without departing from the scope of an aspect of the present disclosure.

In the following description, numerous specific details are given to provide a thorough understanding of aspects. However, it will be apparent that aspects may be practiced without these specific details. To avoid obscuring an aspect, some well-known circuits, system configurations, and process steps are not disclosed in detail.

The drawings showing aspects of the system are semi-diagrammatic, and not to scale. Some of the dimensions are for the clarity of presentation and are shown exaggerated in the drawing figures. Similarly, although the views in the drawings are for ease of description and generally show similar orientations, this depiction in the figures is arbitrary for the most part. Generally, the system may be operated in any orientation.

Certain aspects have other steps or elements in addition to or in place of those mentioned. The steps or elements will become apparent to those skilled in the art from a reading of the following detailed description when taken with reference to the accompanying drawings.

### System Overview and Function

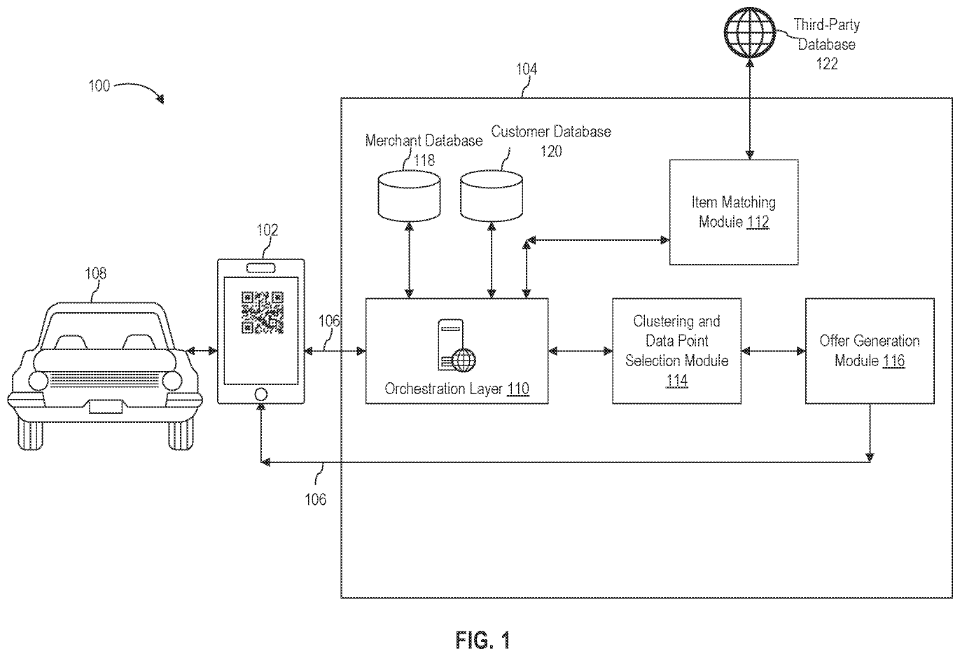

FIG. 1 is an example system 100 for generating offers according to aspects. The offers (or in the singular an offer) refer to suggested deal terms and conditions that are likely to be acceptable to a customer and a merchant when the customer wants to purchase an item from the merchant. In aspects, the system 100 may be implemented on a server 104. The server 104 may be a variety of centralized or decentralized computing devices. For example, the server 104 may be a mobile device, a laptop computer, a desktop computer, grid-computing resources, a virtualized computing resource, cloud computing resources, peer-to-peer distributed computing devices, a server farm, or a combination thereof. The cloud computing resources may be part of a cloud computing environment. The cloud computing environment may be a public or private cloud service. Examples of a public cloud include Amazon Web Services (AWS), IBM Cloud, Oracle Cloud Solutions, Microsoft Azure Cloud, and Google Cloud, as examples. A private cloud refers to a cloud environment similar to a public cloud with the exception that it is operated solely for a single organization.

The server 104 may be centralized in a single room, distributed across different rooms, distributed across different geographic locations, or embedded within a network 106. In aspects, the server 104 can couple with the network 106 to communicate with other devices, such as a client device 102. While the server 104 can couple with the network 106 to communicate with other devices (for example the client device 102), the server 104 can also be a stand-alone device.

The client device 102 may be any of a variety of devices, such as a user mobile device for example a smart phone, a cellular phone, a personal digital assistant, a tablet computer, a notebook computer, a laptop computer, a handheld scanner, etc. The client device 102 can couple, either directly or indirectly, to the network 106 to communicate with the server 104 or may be a stand-alone device.

The network 106 refers to a telecommunications network, such as a wired or wireless network. The network 106 can span and represent a variety of networks and network topologies. For example, the network 106 can include wireless communication, wired communication, optical communication, ultrasonic communication, or a combination thereof. For example, satellite communication, cellular communication, Bluetooth, Infrared Data Association standard (IrDA), wireless fidelity (WiFi), and worldwide interoperability for microwave access (WiMAX) are examples of wireless communication that may be included in the network 106. Cable, Ethernet, digital subscriber line (DSL), fiber optic lines, fiber to the home (FTTH), and plain old telephone service (POTS) are examples of wired communication that may be included in the network 106. Further, the network 106 can traverse a number of topologies and distances. For example, the network 106 can include a direct connection, personal area network (PAN), local area network (LAN), metropolitan area network (MAN), wide area network (WAN), or a combination thereof.

For illustrative purposes, in FIG. 1, the server 104 and the client device 102 are shown as endpoints of the network 106. This, however, is exemplary and it is understood that there may be different partitions between the server 104, the client device 102, and the network 106. For example, the server 104 and the client device 102 may be implemented to function as part of the network 106.

In aspects, the system 100 can include modules to perform some or all of its functionality. The modules can include, an orchestration layer 110, an item matching module 112, a clustering and data point selection module 114, and an offer generation module 116. The modules and how they facilitate the operation of the system 100 will be discussed further below.

Some or all of the modules may be implemented on any of the devices of the system 100. In the aspect shown in FIG. 1, all of the modules are shown as being implemented on the server 104. This, however, is exemplary and in other aspects, some or all of the modules may be implemented on the client device 102.

With respect to the process by which the system 100 generates the offer, in aspects, and as shown in FIG. 1, the system 100 may begin its operation by receiving via an application an identifier identifying an item. In aspects, the identifier can be received from an application on the client device 102. The application refers to a software application or computer program. In aspects, if the client device 102 is a mobile device, the application can be analogous to a mobile application (also referred to as a mobile app.) installed on the client device 102 from which a customer can interact with the system 100. In aspects, if the client device 102 is a notebook computer or desktop computer the application can be a desktop application. In other aspects the application can be installed on a browser of the client device 102 as an applet, widget, or plugin.

In aspects, the customer can utilize the application to provide information to the system 100. In aspects, the information can include information about the item the customer wants to purchase. In aspects, this may be provided manually by selecting the item from a list of items displayed on the screen of the application and having the application transmit pre-populated information about the item to the other components of the system 100. In other aspects, the information can also be provided by scanning a code identifying the item using a camera or scanning unit of the client device 102. For example, the identifier may be a bar code, a QR code, an alphanumeric code, etc. The identifier can have embedded information and/or provide a link to a computer storage location and/or database with the information about the item. The information may be received by the system 100 by either having the system 100 extract the information from the identifier or following a link determined from the identifier and retrieving the information about the item. Alternatively, if a user of the client device 102 is browsing for an item via the application, the identifier can be a code or information stored in cookies or embedded data of a screen or webpage related to the item.

For the purposes of this disclosure and with respect to FIG. 1, the system 100 will be described with respect to the scenario where the identifier is a code that is scanned using a client device 102. With respect to FIG. 1, the aspect shown shows a customer scanning a QR code for a car 108 the customer may want to purchase. Throughout the rest of this disclosure the functionality of the system 100 will be discussed with respect to this aspect. This, however, is not meant to limit the system 100 solely to aspects for purchasing a car 108. The system 100 can function similarly with other items customers desire to purchase.

Continuing with the aspect where the customer wants to purchase the car 108, the customer can use the application to scan the QR code printed on a sales sheet attached to the car 108, or can scan a vehicle identification number (VIN) of the car 108. In aspects, once scanned, the application can transmit the identifier to the other modules of the system 100 via the network 106 or by passing it to the other modules as a variable. In aspects, and based on the identifier, the system 100 can identify the make and model of the car 108 by either extracting the information from the QR code or following a link embedded in the QR code to a computer storage location with that information. Alternatively, if a VIN number is scanned, the system 100 can match the VIN number to one stored in a database, which can provide the system 100 information about the car 108. In aspects, information other than the make and model of the car 108 may also be determined based on the identifier. For example, the identifier can also enable the system 100 to determine which merchant is selling the car 108 based on the car 108 being associated or inventoried with a particular merchant.

In aspects, the identifier may be received by the system 100 at the orchestration layer 110. The orchestration layer 110 refers to a service of the system 100 that can serve as an entry point for the identifier. In aspects, the orchestration layer 110 can coordinate information retrieval and perform task allocations for the system 100. For example, the orchestration layer 110 can comprise one or more software applications, programs, or lines of code that when executed by a processor can implement instructions that facilitate information transmission and retrieval to and/or between the modules of the system 100, and can coordinate execution of the modules.

In aspects, once the identifier is received at the orchestration layer 110, the orchestration layer 110 can pass the identifier to the item matching module 112. The item matching module 112 can enable identifying the item the customer wants to purchase based on the identifier. In aspects, the item matching module 112 can further enable generating a list of alternative inventory items to the identified item. The alternative inventory items can comprise both the exact same item type that the customer wishes to purchase or items similar to the item in classification type, features, category, etc. The item matching module 112 can identify the item and generate the list of alternative inventory items by implementing the system, methods, and processes disclosed in U.S. patent application Ser. No. 17/104,684, filed on Nov. 25, 2020, entitled “MATCHING INVENTORY CHARACTERISTICS AND STRUCTURE,” the contents of which is incorporated by reference herein in its entirety.

The purpose of generating the list of alternative inventory items is to gather a list of similar items to the item the customer wants to purchase so as to be able to gather a pool of data related to historic deal metrics for those similar items. The historic deal metrics may be used by the system 100 to generate the offer by having the system 100 process the historic deal metrics to determine what deal terms were acceptable in the past to both merchants and customers for the similar items. From the determination, an offer may be generated that is likely to be acceptable to both the customer and the merchant.

In aspects, the item matching module 112 can generate the list of alternative inventory items to the item based on accessing a third-party database 122. The third-party database 122 can contain product information that may be used to generate the list of alternative inventory items. In aspects, the third-party database 122 may be managed by a third-party vendor, which is external and independent of the company or institution implementing the system 100.

By way of example, where the customer wants to purchase the car 108, the list of alternative inventory items can comprise cars that are similar or the same as the car 108 in terms of make, model, body style, vehicle category, features, etc. that were the subject of past sales. In aspects, the list of alternative inventory items and the associated information for those alternative inventory items may be saved in a computer file, such as a text file or as entries in a database by the item matching module 112.

In aspects, once the item matching module 112 generates the list of alternative inventory items, control and the list of alternative inventory items may be passed back to the orchestration layer 110. In aspects, the orchestration layer 110 can enable determining a plurality of historic deal metrics for both a merchant selling the item and for customers that are financially similarly situated as the customer wanting to purchase the item. This is done by retrieving past deal information for each of the items listed in the list of alternative inventory items. For example, the historic deal metrics (i.e., past deal information) for a merchant can include, for each of the alternative items in the list of alternative inventory items, a sales price that that item sold for, the financing terms for that sale, any discounts applied, any credits given, down payment amounts accepted, etc. The historic deal metrics for customers can include, for each of the alternative items in the list of alternative inventory items, a sales price that was accepted for that item, the financing terms for that item, any down payments made, the credit score of that customer, account balances of that customer, monthly income range of that customer, etc. The aforementioned are exemplary metrics that may be included as part of the historic deal metrics. A person of ordinary skill in the art (POSA) will recognize other metrics that may be used, and that relate to the purchasing and/or financing of items such as the car 108.

In aspects, the historic deal metrics may be obtained from various databases or repositories that the system 100 has access to. For example, historic deal metrics for the merchant may be obtained from a merchant database 118 that stores the historic deal metrics. In aspects, the historic deal metrics may be based on past deals that were financed through the company or institution implementing the system 100. For example, if the company or institution implementing the system 100 is a bank, the historic deal metrics for the merchant may be based on purchases made and/or financed through the bank, which may be stored in databases or repositories of the bank. In some aspects, the historic information may be obtained from the merchants directly, by having the merchants voluntarily provide the information and/or access to a database via application programming interfaces (APIs) and database programs that have the information.

Similarly, the historic deal metrics for the customers may be obtained from a customer database 120 that stores the historic deal metrics, and that may be based on past deals that were financed through the company or institution implementing the system 100. Alternatively or in conjunction, the information may be obtained by accessing databases for credit agencies, partner institutions, merchants, etc., to obtain information about past purchases for the alternative inventory items.

In aspects, in addition to obtaining historic deal metrics for the merchant and customers that have purchased similar items, the orchestration layer 110 can also obtain customer information about the customer that is seeking to purchase the item. Throughout this disclosure, it is assumed that the customer wanting to purchase the item is a user that has an associated user account on the application, and that the customer via the user account is the one using the application to perform the scanning of the item to be purchased.

In aspects, the customer information for the customer wanting to purchase the item can include a credit score information, information regarding their bank account balances, monthly income range, etc., such that the financial circumstance and purchasing power of the customer may be determined by the system 100. In aspects, the information about the customer may be obtained from the same or a different database as that from which the other customer's information is obtained (e.g., the customer database 120). The purpose of obtaining the customer information is for the system 100 to be able to filter the plurality of customer historic deal metrics based on the customer information, in order to identify only those customers that made past purchases that are similarly situated financially to the customer wishing to purchase the item. In this way, past deal information for customers most closely resembling the customer wanting to purchase the item is only analyzed by the system 100 to generate the offer.

In aspects, once the orchestration layer 110 obtains the plurality of historic deal metrics for both the merchant and customers that have made past purchases, and the customer wanting to purchase the item, the orchestration layer 110 can perform a filtering on the plurality of customer historic deal metrics. This filtering, as indicated, serves the purpose of removing any historic deal metrics for customers that are not financially similarly situated as the customer wanting to purchase the item. The filtering also allows the system 100 to process only a subset of data from that pulled from the various databases, thus reducing the amount of data processing performed by the system 100, and speeding up the computations of the system 100. Various methods may be implemented to perform the filtering. For example, in aspects, the filtering can include filtering the plurality of customer historic deal metrics to include only customer historic deal metrics for customers within a banded credit risk profile as the customer wishing to purchase the item (in this case the user associated with the user account of the application from which the identifier is received). The banded credit risk profile refers to the customers being within a credit score of the customer wishing to purchase the item plus a predetermined threshold value. Thus, only information related to customers with the same or similar credit scores as the customer wishing to purchase the item is analyzed. In aspects, the filtering can further include filtering the plurality of customer historic deal metrics to include only customer historic deal metrics for customers within a monthly income range as the customer wishing to purchase the item. The aforementioned are exemplary ways to filter customer historic deal metrics to align customers who made past purchases with the customer wishing to purchase the item. Other methods may be used based on other criteria and data that is pulled to perform the filtering.

In aspects, once the filtering is performed, control and the filtered historic deal metrics may be passed to the clustering and data point selection module 114. The clustering and data point selection module 114 enables generating clusters of data points based on the historic deal metrics. In aspects, the clustering and data point selection module 114 does this by implementing a clustering procedure in which the historic deal metrics for both the merchants and the customers for each of the past deals of each item in the list of alternative inventory items is gathered into a data structure and passed through a clustering algorithm. In aspects, the clustering procedure can generate a data point based on past deal information and individually plot the data points in an N-dimensional space, where N is a positive integer. By way of example, and taking the example of the purchase of the car 108, historic deal metrics for past sales of the same or similar cars by the merchants and their deal terms may be gathered individually, each in an array, and the array may be passed through a clustering procedure such that the array may be represented as a data point in an N-dimensional space. This may be done across all deals performed for all alternative inventory items in the list for which historic deal metrics exist. Similarly, historic deal metrics for past sales of similar cars from customer perspectives may be gathered individually, each in an array, and the array passed through the same clustering procedure such that the array may be represented as a data point in the N-dimensional space. As a result, two sets of data points may be generated by the clustering and data point selection module 114 (a first cluster of data points based on the plurality of merchant historic deal metrics and a second cluster of data points based on the plurality of customer historic deal metrics). Various clustering procedures may be utilized by the clustering and data point selection module 114, as will be recognized by a POSA. For example, clustering procedures based on centroid-based clustering, density-based clustering, distribution-based clustering, and/or hierarchical clustering procedures, or a combination thereof may be used to perform the clustering.

In aspects, once the two clusters (the first cluster of data points and the second cluster of data points) are generated, the clustering and data point selection module 114 can determine an overlap region between the first cluster and the second cluster. The overlap region refers to an area in which data points of both the first and second clusters overlap. The overlap region may be determined in a variety of ways as will be recognized by a POSA. In aspects, the size of the overlap region may be customized by a designer of the system 100. For example, in aspects, the overlap region may be determined by determining a radius for each cluster from a center point determined for each cluster and drawing a circle based on the radius and center point. The overlap region may be determined as the portion of the circles that overlap with one another. The aforementioned is an example, and other ways of determining an overlap region may be utilized. The purpose of determining the overlap region is to determine what deal terms are common to both merchants and customers. Thus, the data points within the overlap region represent a range of deal terms that have been deemed acceptable to both the merchant and the customers and that have terms that are either the same or similar. The data points within the overlap region may be utilized such that their associated deal terms can serve as potential deal terms the offer may be generated or derived from.

In aspects, once the overlap region is determined between the first and second clusters, the clustering and data point selection module 114 can select a data point from amongst the data points within the overlap region. Again, various methods and processes may be utilized to perform the selection. The methods and processes used for selecting the data point may be customized by a designer of the system 100. For example, in aspects, and in a simple implementation, the data point can be selected randomly from amongst the data points within the overlap region. In more complex implementations, and in aspects, the data point may be selected based on determining an average sales price based on the past purchases for each of the alternative inventory items for which data points are within the overlap region, and selecting the data point from amongst the data points within the overlap region that has a sales price value closest to the average sales price. In other aspects, the data point may be selected based on determining the average sales price based on past purchases for each of the alternative inventory items that represent the same item as the one wanting to be purchased that are within the overlap region. Other methods may be used based on calculating averages or values for other historic deal metrics and/or combining such calculated values to aid in the selection of the data point. In aspects, weightings can be given to give preferences to data points from either of the first or second clusters that fall within the overlap region so that a data point can be chosen preferably from one cluster rather than the other. The aforementioned are exemplary way to select a data point. Other variations or combinations can be used.

In aspects, once the data point is selected from amongst the data points in the overlap region, control and the historic deal metrics associated with the data point may be passed to the offer generation module 116. The offer generation module 116 can enable generating an offer for the item based on the selected data point. This may be done in a variety of ways. For example, in aspects, the offer generation module 116 can generate the offer by copying the deal terms of the selected data point and generating the offer based on the same terms. In other aspects, the offer generation module 116 can further customize the offer by modifying the deal terms associated with the selected data point so that it better matches the financial situation of the customer and/or any updated deal terms required by the merchant. For example, the customization may be based on account balances of the customer, any promotional incentives offered by the merchant, etc., which may be used to adjust deal terms by a dollar amount so as to meet requirements or constraints of the customer and/or the merchant, but still be acceptable for both parties.

In aspects, once the offer is generated, the offer generation module 116 can transmit the offer to further devices so that it may be utilized by the merchant and/or the customer as a starting point for negotiating the purchase of the item. In aspects, the offer may be packaged as a part of a report or a graphic, and transmitted to a device (e.g., the client device 102) for display on a GUI.

In aspects, the system 100 can also learn from the offers it generates, and can have feedback input back into the system 100 relating to whether the offer was accepted or not, how much the offer was off by, what the ultimate acceptable terms of the offer were, etc. so as to continually learn and to constantly improve its ability to generate offers. For example, this may be done by having the terms of the negotiation for which the system 100 generated an offer for, fed back into the databases from which historic deal metrics are obtained and may be used by the system 100 as data from which it can generate future offers from. In this way, the system 100 can continuously build on its outputs and further refine its ability to make offers as the data points increase. In aspects, machine learning processes and/or algorithms may be used to facilitate this learning process and train the system 100 to generate improved offers. For example, machine learning/artificial intelligence architectures such as neural networks may be implemented as a part of the system 100 to learn patterns of offers, so that the system 100 can used those learnings and/or patterns to generate future offers. In this way, the system 100 may become more intelligent as the data pool of deals increases.

In aspects, the system 100 can also be implemented as a real-time system such that the system 100 generates the offer in real-time from when the identifier identifying the item is received. Real-time refers to the system 100 generating the offer within milliseconds or seconds from when the identifier is received so that the offer is able to be transmitted to the client device 102 almost instantly from when the client device 102 scans the identifier.

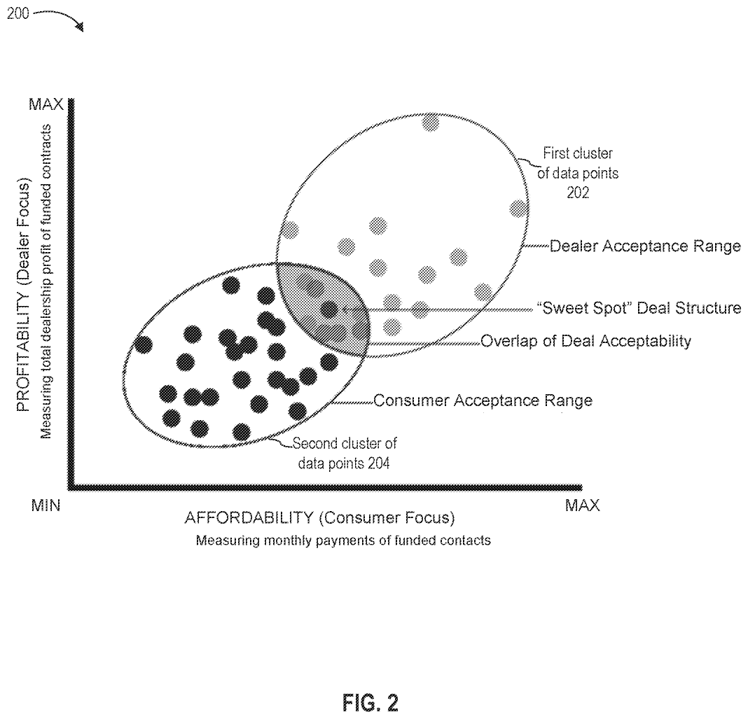

FIG. 2 is an example of the clustering performed by the system 100 according to aspects. FIG. 2 shows a two-dimensional plot 200 showing the clusters of data points generated by the system 100. The various data points represent the first cluster of data points 202 and the second cluster of data points 204, as described in FIG. 1. The regions labeled “dealer acceptance range” and “consumer acceptance range” represent the deal terms that have been acceptable to merchants and customers in past deals for each of the alternative inventory items. The region labeled “overlap of deal acceptability” represents the overlap region, as described in FIG. 1. The data point labeled “‘sweet spot’ deal structure” represents the selected data point, as described in FIG. 1. Plot 200 shows the data points along two axes indicating what the profitability range is for the merchant (and in the case of FIG. 2, the car's 108 dealer) against the affordability range for customers (as measured by what monthly payments are acceptable to customers).

The modules described in FIG. 1, and which can generate the clusters shown in FIG. 2, may be implemented as instructions stored on a non-transitory computer readable medium to be executed by one or more computing units such as a processor, a special purpose computer, an integrated circuit, integrated circuit cores, or a combination thereof. The non-transitory computer readable medium may be implemented with any number of memory units, such as a volatile memory, a nonvolatile memory, an internal memory, an external memory, or a combination thereof. The non-transitory computer readable medium may be integrated as a part of the system 100 or installed as a removable portion of the system 100.

It has been discovered that the system 100 described above improves the state of the art from conventional systems because it provides a novel way to generate highly targeted offers that can serve as starting points in the negotiation process for the purchase of items. The system does this by taking into account historic deal metrics for both merchants and customers to generate offers and processes these deal metrics using clustering procedures to determine a data point representing a historic deal term for the same or similar item which has previously been deemed acceptable by the merchant and customers. The ability of the system 100 to provide these targeted offers significantly reduces time negotiating deal terms by leveraging technology and data in an intelligent manner to derive deal terms likely to be acceptable to both parties. Thus, by leveraging data intelligently the system 100 saves merchants and customers time and money when purchasing items.

The system 100 also improves conventional systems by implementing machine learning features that can enable the system 100 to learn from the offers it generates. The machine learning capabilities can ensure that the system 100 learns from its past offers and learns patterns based on past accepted deal terms. This in combination with the use of the historic deal metrics for both merchants and customers that are similarly situated as the customer wanting to purchase the product or service provides a highly customized offer that greatly improves the chance that the offer will be acceptable to both the merchant and customer. In this way, the system 100 can continuously improve its ability to generate offers, resulting in a more intelligent computing system that can ultimately provide offers that do not need to be negotiated by either the merchant or the customer.

The system 100 also improves conventional systems by implementing an intelligent computer based system that can generate custom offers in real-time to merchants and customers. The custom offers can be generated almost instantly from the time the customer decides he or she wants to purchase an item. By providing a custom offer instantly, the system 100 can bypass hours or days of back and forth between customers and merchants. Moreover, both the merchant and customer will know that the offer presented is one that is acceptable to both instantly. This latter aspect also allows both merchants and customers to transact confidently, especially on the part of the customer, which can know that the offer presented is not one in which he or she is being overcharged for the item.

### Methods of Operation

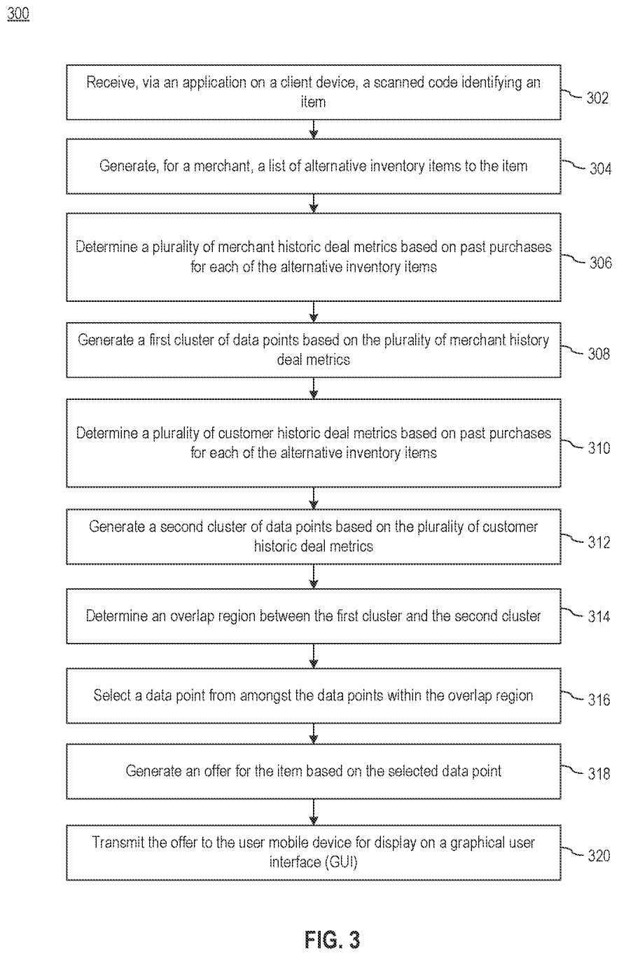

FIG. 3 is an example method 300 of operating the system 100 according to aspects. Method 300 may be performed as a series of steps. At step 302, the system 100 can receive, via an application, a identifier identifying an item. At step 304, for a merchant, a list of alternative inventory items to the item may be generated. At step 306, the system 100 can determine a plurality of merchant historic deal metrics based on past purchases for each of the alternative inventory items. At step 308, a first cluster of data points may be generated based on the plurality of merchant historic deal metrics. At step 310, the system 100 can determine a plurality of customer historic deal metrics based on past purchases for each of the alternative inventory items. At step 312, a second cluster of data points may be generated based on the plurality of customer historic deal metrics. At step 314, an overlap region may be determined between the first cluster and the second cluster. At step 316, a data point from amongst the data points within the overlap region may be selected. At step 318, an offer may be generated for the item based on the selected data point. At step 320, the offer may be transmitted to the client device 102 for display on a graphical user interface (GUI).

The operation of method 300 is performed, for example, by system 100, in accordance with aspects described above.

### GUI Interfaces of the System

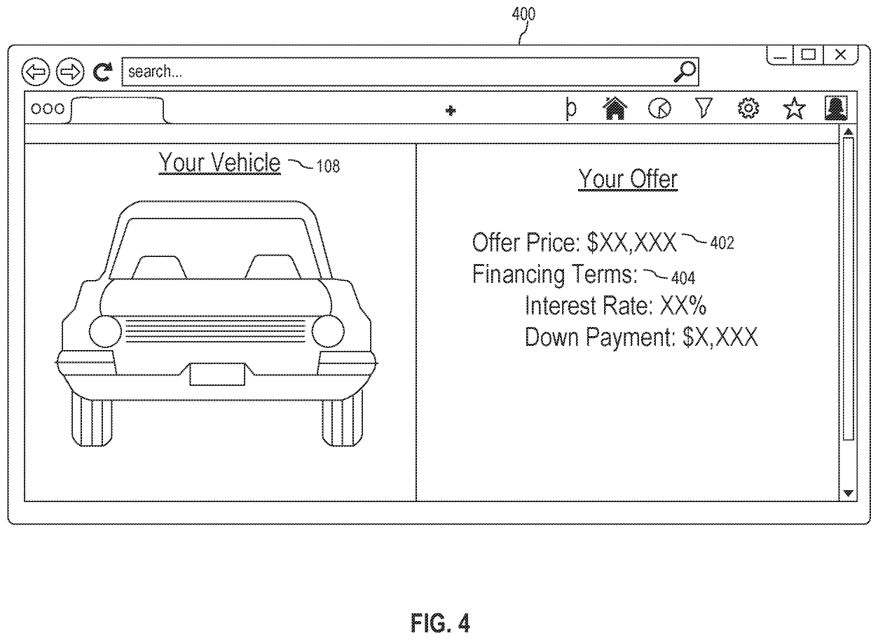

FIG. 4 is an example GUI 400 displaying the offer to a customer according to aspects. In aspects, the GUI 400 may be displayed on the client device 102, via the application. In aspects, what may be displayed on the GUI 400 as part of the offer is the offer price 402 and any financing terms 404, including for example, an interest rate and/or down payment amount. In aspects, other information may be displayed. For example, in the aspect where the customer wants to purchase the car 108, a graphic of the car 108 and/or a description of the features of the car 108 can also be displayed in a window or pane of the GUI 400.

### Components of the System

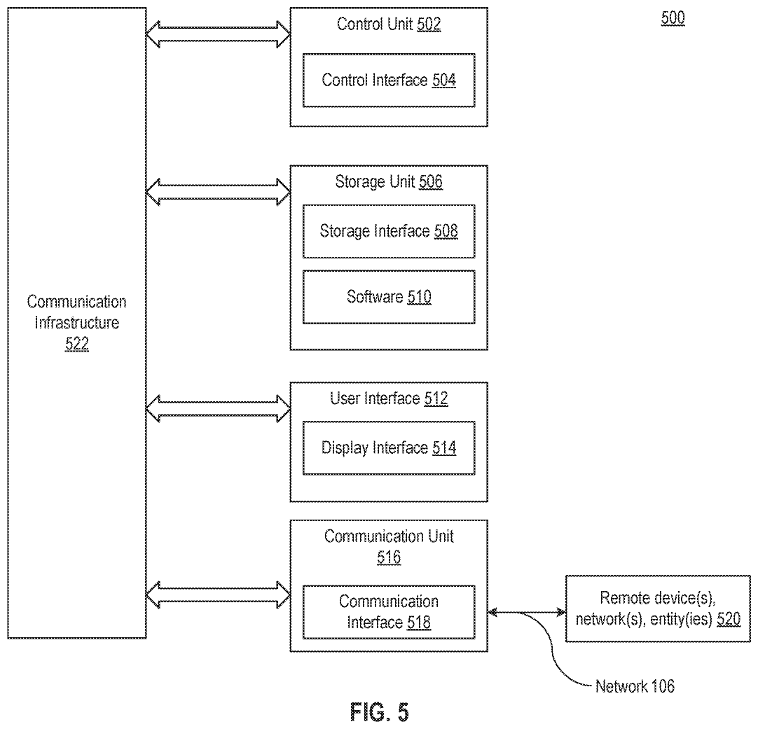

FIG. 5 is an example architecture 500 of the components of the system 100 according to aspects. The components may be the components of the server 104 on which the system 100 is implemented, or may be components of the client device 102. In aspects, the components may include a control unit 502, a storage unit 506, a communication unit 516, and a user interface 512. The control unit 502 may include a control interface 504. The control unit 502 may execute a software 510 to provide some or all of the intelligence of system 100. The control unit 502 may be implemented in a number of different ways. For example, the control unit 502 may be a processor, an application specific integrated circuit (ASIC), an embedded processor, a microprocessor, a hardware control logic, a hardware finite state machine (FSM), a digital signal processor (DSP), a field programmable gate array (FPGA), a graphics processing unit (GPU) or a combination thereof.

The control interface 504 may be used for communication between the control unit 502 and other functional units or devices of system 100. The control interface 504 may also be used for communication that is external to the functional units or devices of system 100. The control interface 504 may receive information from the functional units or devices of system 100, or from remote devices 520, for example the third-party database 122, or may transmit information to the functional units or devices of system 100, or to remote devices 520. The remote devices 520 refer to units or devices external to system 100.

The control interface 504 may be implemented in different ways and may include different implementations depending on which functional units or devices of system 100 or remote devices 520 are being interfaced with the control unit 502. For example, the control interface 504 may be implemented with a pressure sensor, an inertial sensor, a microelectromechanical system (MEMS), optical circuitry, waveguides, wireless circuitry, wireline circuitry to attach to a bus, an application programming interface, or a combination thereof. The control interface 504 may be connected to a communication infrastructure 522, such as a bus, to interface with the functional units or devices of system 100 or remote devices 520.

The storage unit 506 may store the software 510. For illustrative purposes, the storage unit 506 is shown as a single element, although it is understood that the storage unit 506 may be a distribution of storage elements. Also for illustrative purposes, the storage unit 506 is shown as a single hierarchy storage system, although it is understood that the storage unit 506 may be in a different configuration. For example, the storage unit 506 may be formed with different storage technologies forming a memory hierarchical system including different levels of caching, main memory, rotating media, or off-line storage. The storage unit 506 may be a volatile memory, a nonvolatile memory, an internal memory, an external memory, or a combination thereof. For example, the storage unit 506 may be a nonvolatile storage such as nonvolatile random access memory (NVRAM), Flash memory, disk storage, or a volatile storage such as static random access memory (SRAM) or dynamic random access memory (DRAM).

The storage unit 506 may include a storage interface 508. The storage interface 508 may be used for communication between the storage unit 506 and other functional units or devices of system 100. The storage interface 508 may also be used for communication that is external to system 100. The storage interface 508 may receive information from the other functional units or devices of system 100 or from remote devices 520, or may transmit information to the other functional units or devices of system 100 or to remote devices 520. The storage interface 508 may include different implementations depending on which functional units or devices of system 100 or remote devices 520 are being interfaced with the storage unit 506. The storage interface 508 may be implemented with technologies and techniques similar to the implementation of the control interface 504.

The communication unit 516 may enable communication to devices, components, modules, or units of system 100 or to remote devices 520. For example, the communication unit 516 may permit the system 100 to communicate between the server 104 on which the system 100 can be implemented and the client device 102. The communication unit 516 may further permit the devices of system 100 to communicate with remote devices 520 such as an attachment, a peripheral device, or a combination thereof through the network 106.

As previously indicated, the network 106 may span and represent a variety of networks and network topologies. For example, the network 106 may be a part of a network and include wireless communication, wired communication, optical communication, ultrasonic communication, or a combination thereof. For example, satellite communication, cellular communication, Bluetooth, Infrared Data Association standard (IrDA), wireless fidelity (WiFi), and worldwide interoperability for microwave access (WiMAX) are examples of wireless communication that may be included in the network 106. Cable, Ethernet, digital subscriber line (DSL), fiber optic lines, fiber to the home (FTTH), and plain old telephone service (POTS) are examples of wired communication that may be included in the network 106. Further, the network 106 may traverse a number of network topologies and distances. For example, the network 106 may include direct connection, personal area network (PAN), local area network (LAN), metropolitan area network (MAN), wide area network (WAN), or a combination thereof.

The communication unit 516 may also function as a communication hub allowing system 100 to function as part of the network 106 and not be limited to be an end point or terminal unit to the network 106. The communication unit 516 may include active and passive components, such as microelectronics or an antenna, for interaction with the network 106.

The communication unit 516 may include a communication interface 518. The communication interface 518 may be used for communication between the communication unit 516 and other functional units or devices of system 100 or to remote devices 520. The communication interface 518 may receive information from the other functional units or devices of system 100, or from remote devices 520, or may transmit information to the other functional units or devices of the system 100 or to remote devices 520. The communication interface 518 may include different implementations depending on which functional units or devices are being interfaced with the communication unit 516. The communication interface 518 may be implemented with technologies and techniques similar to the implementation of the control interface 504.

The user interface 512 may present information generated by system 100. In aspects, the user interface 512 allows users to interface with the system 100. In aspects, the user interface 512 can present the GUI 400 which any customers can interact with to receive offers. The user interface 512 may include an input device and an output device. Examples of the input device of the user interface 512 may include a keypad, buttons, switches, touchpads, soft-keys, a keyboard, a mouse, or any combination thereof to provide data and communication inputs. Examples of the output device may include a display interface 514. The control unit 502 may operate the user interface 512 to present information generated by system 100. The control unit 502 may also execute the software 510 to present information generated by system 100, or to control other functional units of system 100. The display interface 514 may be any GUI such as a display, a projector, a video screen, or any combination thereof.

The terms “module” or “unit” referred to in this disclosure can include software, hardware, or a combination thereof in an aspect of the present disclosure in accordance with the context in which the term is used. For example, the software may be machine code, firmware, embedded code, or application software. Also for example, the hardware may be circuitry, a processor, a special purpose computer, an integrated circuit, integrated circuit cores, or a combination thereof. Further, if a module or unit is written in the system or apparatus claims section below, the module or unit is deemed to include hardware circuitry for the purposes and the scope of the system or apparatus claims.

The terms “service” or “services” referred to herein can include a collection of modules or units. A collection of modules or units may be arranged, for example, in software or hardware libraries or development kits in an aspect of the present disclosure in accordance with the context in which the term is used. For example, the software or hardware libraries and development kits may be a suite of data and programming code, for example pre-written code, classes, routines, procedures, scripts, configuration data, or a combination thereof, that may be called directly or through an application programming interface (API) to facilitate the execution of functions of the system 100.

The modules, units, or services in the following description of the aspects may be coupled to one another as described or as shown. The coupling may be direct or indirect, without or with intervening items between coupled modules, units, or services. The coupling may be by physical contact or by communication between modules, units, or services.

The above detailed description and aspects of the disclosed system 100 are not intended to be exhaustive or to limit the disclosed system 100 to the precise form disclosed above. While specific examples for system 100 are described above for illustrative purposes, various equivalent modifications are possible within the scope of the disclosed system 100, as those skilled in the relevant art will recognize. For example, while processes and methods are presented in a given order, alternative implementations may perform routines having steps, or employ systems having processes or methods, in a different order, and some processes or methods may be deleted, moved, added, subdivided, combined, or modified to provide alternative or sub-combinations. Each of these processes or methods may be implemented in a variety of different ways. Also, while processes or methods are at times shown as being performed in series, these processes or blocks may instead be performed or implemented in parallel, or may be performed at different times.

The resulting method 300 and system 100 is cost-effective, highly versatile, and accurate, and may be implemented by adapting components for ready, efficient, and economical manufacturing, application, and utilization. Another important aspect of aspects of the present disclosure is that it valuably supports and services the historical trend of reducing costs, simplifying systems, and/or increasing performance.

These and other valuable aspects of the present disclosure consequently further the state of the technology to at least the next level. While the disclosed aspects have been described as the best mode of implementing system 100, it is to be understood that many alternatives, modifications, and variations will be apparent to those skilled in the art in light of the descriptions herein. Accordingly, it is intended to embrace all such alternatives, modifications, and variations that fall within the scope of the included claims. All matters set forth herein or shown in the accompanying drawings are to be interpreted in an illustrative and non-limiting sense.

1. A computer implemented method comprising:
receiving, by one or more computing devices and from an application, a scanned barcode with embedded information identifying a vehicle of interest;
generating, by the one or more computing devices and for a merchant, a list of vehicles with either the same or similar features to the vehicle of interest, and that have previously been subject to a transaction by the merchant;
determining, by the one or more computing devices, a plurality of merchant historic deal metrics for each vehicle in the list of vehicles;
generating, by the one or more computing devices and using a clustering algorithm, a first cluster of data points in a N-dimensional space based on passing the plurality of merchant historic deal metrics through the clustering algorithm using a first common data structure;
determining, by the one or more computing devices and for a plurality of customers, customer historic deal metrics based on past purchases of each vehicle in the list of vehicles;
generating, by the one or more computing devices and using the clustering algorithm, a second cluster of data points in the N-dimensional space based on passing the plurality of customer historic deal metrics through the clustering algorithm using a second common data structure;
determining, by the one or more computing devices, an overlap region between the first cluster and the second cluster representing similar deal metrics, wherein the overlap region is determined based on:
determining a radius based on a center point for each of the first cluster of data points and the second cluster of data points;
outlining circles based on the radius and the center point for each of the first cluster of data points and the second cluster of data points; and
determining which areas of the circles overlap;
selecting, by the one or more computing devices, a data point from amongst the data points within the overlap region;
generating, by the one or more computing devices, an offer for the item vehicle of interest based on the selected data point;
transmitting, by the one or more computing devices, the offer to the client device for display on a graphical user interface (GUI);
receiving, by the one or more computing devices, a feedback indicating whether the offer was accepted or denied; and
based on the offer being accepted, storing, by the one or more computing devices, the offer as part of the plurality of merchant historic deal metrics and customer historic deal metrics for future use in subsequent iterations of the method.

2. The method of claim 1, wherein selecting the data point comprises randomly selecting a data point from amongst the data points within the overlap region.

3. The method of claim 1, wherein selecting the data point comprises:
determining an average sales price based on the past purchases for each vehicle in the list of vehicles for which data points are within the overlap region; and
selecting the data point from amongst the data points within the overlap region that has a sales price value closest to the average sales price.

4. The method of claim 1, further comprising generating, by the one or more computing devices, the offer in real-time from when the scanned barcode is received.

5. The method of claim 1, further comprising filtering, by the one or more computing devices, the plurality of customer historic deal metrics to include only customer historic deal metrics for customers within a banded credit risk profile.

6. The method of claim 1, further comprising filtering, by the one or more computing devices, the plurality of customer historic deal metrics to include only customer historic deal metrics for customers within a predetermined monthly income range.

7. The method of claim 1, wherein the method is implemented on devices of a cloud-computing environment.

8. A non-transitory computer readable medium including instructions that when executed by a processor, cause the processor to perform operations comprising:
receiving, from an application, a scanned barcode with embedded information identifying a vehicle of interest;
generating, for a merchant, a list of vehicles with either the same or similar features to the vehicle of interest, and that have previously been subject to a transaction by the merchant;
determining a plurality of merchant historic deal metrics for each vehicle in the list of vehicle;
generating, using a clustering algorithm, a first cluster of data points in a N-dimensional space based on passing the plurality of merchant historic deal metrics through the clustering algorithm using a first common data structure;
determining, for a plurality of customers, customer historic deal metrics based on past purchases of each vehicle in the list of vehicles;
generating, using the clustering algorithm, a second cluster of data points in the N-dimensional space based on passing the plurality of customer historic deal metrics through the clustering algorithm using a second common data structure;
determining an overlap region between the first cluster and the second cluster representing similar deal metrics, wherein the overlap region is determined based on:
determining a radius based on a center point for each of the first cluster of data points and the second cluster of data points;
outlining circles based on the radius and the center point for each of the first cluster of data points and the second cluster of data points; and
determining which areas of the circles overlap;
selecting a data point from amongst the data points within the overlap region;
generating an offer for the vehicle of interest based on the selected data point;
transmitting the offer to the client device for display on a graphical user interface (GUI);
receiving a feedback indicating whether the offer was accepted or denied; and
based on the offer being accepted, storing the offer as part of the plurality of merchant historic deal metrics and customer historic deal metrics for future use in subsequent iterations of the operations.

9. The non-transitory computer readable medium of claim 8, wherein the operations further comprise selecting the data point by randomly selecting a data point from amongst the data points within the overlap region.

10. The non-transitory computer readable medium of claim 8, wherein the operations further comprise selecting the data point by:
determining an average sales price based on the past purchases for each vehicle in the list of vehicles for which data points are within the overlap region; and
selecting the data point from amongst the data points within the overlap region that has a sales price value closest to the average sales price.

11. The non-transitory computer readable medium of claim 8, wherein the operations further comprise generating the offer in real-time from when the scanned barcode is received.

12. The non-transitory computer readable medium of claim 8, wherein the operations further comprise filtering the plurality of customer historic deal metrics to include only customer historic deal metrics for customers within a banded credit risk profile.

13. The non-transitory computer readable medium of claim 8, wherein the operations further comprise filtering the plurality of customer historic deal metrics to include only customer historic deal metrics for customers within a predetermined monthly income range.

14. A computing system comprising:
a communication unit including microelectronics configured to:
receive, via an application, a scanned barcode with embedded information identifying a vehicle of interest;
a processor, coupled to the communication unit, configured to:
generate, for a merchant, a list of vehicles with either the same or similar features to the vehicle of interest, and that have previously been subject to a transaction by the merchant,
determine a plurality of merchant historic deal metrics for each vehicle in the list of vehicle,
generate, using a clustering algorithm, a first cluster of data points in a N-dimensional space based on passing the plurality of merchant historic deal metrics through the clustering algorithm using a first common data structure,
determine, for a plurality of customers, customer historic deal metrics based on past purchases of each vehicle in the list of vehicles,
generate, using the clustering algorithm, a second cluster of data points in the N-dimensional space based on passing the plurality of customer historic deal metrics through the clustering algorithm using a second common data structure,
determine an overlap region between the first cluster and the second cluster representing similar deal metrics, wherein the overlap region is determined based on:
determining a radius based on a center point for each of the first cluster of data points and the second cluster of data points;
outlining circles based on the radius and the center point for each of the first cluster of data points and the second cluster of data points; and
determining which areas of the circles overlap,
select a data point from amongst the data points within the overlap region, generate an offer for the vehicle of interest based on the selected data point;
wherein the communication unit is further configured to:
transmit the offer to the client device for display on a graphical user interface (GUI), and
receive a feedback indicating whether the offer was accepted or denied; and
based on the offer being accepted, the processor is further configured to store the offer as part of the plurality of merchant historic deal metrics and customer historic deal metrics for future use in subsequent iterations by the computing system.

15. The computing system of claim 14, wherein the processor is further configured to select the data point by randomly selecting a data point from amongst the data points within the overlap region.

16. The computing system of claim 14, wherein the processor is further configured to select the data point by:
determining an average sales price based on the past purchases for each vehicle in the list of vehicles for which data points are within the overlap region; and
selecting the data point from amongst the data points within the overlap region that has a sales price value closest to the average sales price.

17. The computing system of claim 14, wherein the processor is further configured to generate the offer in real-time from when the scanned barcode is received.

18. The computing system of claim 14, wherein the processor is further configured to filter the plurality of customer historic deal metrics to include only customer historic deal metrics for customers within a banded credit risk profile.

19. The computing system of claim 14, wherein the processor is further configured to filter the plurality of customer historic deal metrics to include only customer historic deal metrics for customers within a predetermined monthly income range.

20. The computing system of claim 14, wherein the computing system is implemented on devices of a cloud-computing environment.
